(19) United States
(12) Patent Application Publication
(10) Pub. No.: US 2009/0090123 A1
(43) Pub. Date: Apr. 9, 2009

(54) Refrigerator Controlling Water Supply and Control Method Thereof

(75) Inventors: Seok Jun Son, Gwangju (KR); Seong Ki Jeong, Yongin-si (KR); Young Woon Kwon, Gwangju (KR); Jin Oh Seok, Gwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/153,603

(22) Filed: May 21, 2008

(30) Foreign Application Priority Data
Oct. 9, 2007 (KR) 10-2007-0101222

(51) Int. Cl. B67D 5/62; F16K 31/02; G06F 17/00; B67D 5/08

(52) U.S. Cl. 62/389; 251/129.01; 700/231; 222/544

(57) ABSTRACT

A refrigerator which supplies water by driving a water valve installed on a flow path connected between a water supply source and a dispenser and a control method thereof are disclosed. A driving voltage is applied to the water valve in a start-up operation and the phase of the driving voltage applied to the water valve is controlled after the start-up operation to reduce an average voltage, thereby preventing a malfunction due to overheat of the water valve.

### CROSS-REFERENCE TO RELATED APPLICATIONS

This application claims the benefit of Korean Patent Application No. 2007-0101222, filed on Oct. 9, 2007 in the Korean Intellectual Property Office, the disclosure of which is incorporated herein by reference.

### BACKGROUND

1. Field

The present invention relates to a refrigerator and a control method thereof, and, more particularly, to a refrigerator which controls an amount of water supplied to a dispenser using a water valve and a control method thereof.

2. Description of the Related Art

Generally, a refrigerator is an electric home appliance capable of maintaining freshness of stored food for a long period of time by supplying cool air generated from an evaporator to a storage chamber. Various refrigerators are being developed to meet various demands of consumers. For example, there are an upright refrigerator having a freezing chamber and a cooling chamber that are vertically disposed and a side-by-side refrigerator having a freezing chamber and a cooling chamber that are laterally disposed to have a larger effective volume.

Recently, the refrigerator has included various units for functionality and convenience in addition to essential units to freshly store food. Along with this trend, a dispenser is commonly installed to supply water without opening a door.

Generally, a refrigerator having a dispenser includes a water supply line which connects an external water supply source, a cold water tank that stores water therein and the dispenser with each other and forms a flow path of water to be supplied to the dispenser.

A water valve is installed on the water supply line to control the supply of water. An operation of the water valve is controlled according to the demand of water supply. The water valve has a coil to reciprocate a plunger disposed therein, thereby opening or closing the water path. A driving voltage is applied to the coil.

When an excessive driving voltage is applied to the water valve, a bobbin with a coil wound thereon may be overheated and melted. Accordingly, since the plunger may not be operated or may malfunction, water may not be smoothly supplied due to an operation error of the water valve.

### SUMMARY

The present embodiment has been made in order to solve the above problems. It is an aspect of the embodiment to control a driving voltage applied to a water valve to supply water to a dispenser, thereby preventing a malfunction of the valve.

Additional aspects and/or advantages will be set forth in part in the description which follows and, in part, will be apparent from the description, or may be learned by practice of the invention.

The foregoing and/or other aspects are achieved by providing a refrigerator, including: a dispenser; a water supply line to supply water to the dispenser; a water valve disposed on the water supply line; a valve driving unit to drive the water valve; and a controller which controls the valve driving unit to selectively apply a plurality of driving voltages having different average voltages to the water valve according to an operation mode.

The controller may apply a driving voltage having a high average voltage to the water valve in a start-up operation and apply a driving voltage having a low average voltage to the water valve after the start-up operation.

The valve driving unit may control a ratio of supply to supply interruption of the driving voltage in order to adjust the average voltage.

The water valve may include a coil to be applied with the driving voltage.

The foregoing and/or other aspects are achieved by providing a refrigerator having a dispenser, including: a valve disposed on a flow path through which water is supplied to the dispenser; a valve driving unit which applies a driving voltage to the valve; and a controller which controls the valve driving unit to apply a second driving voltage, which has an average voltage smaller than that of a first driving voltage supplied to the refrigerator, to the valve.

The valve driving unit may control a ratio of supply to supply interruption of the driving voltage in order to reduce the average voltage.

A reduced rate of the average voltage may be 10˜15%.

The foregoing and/or other aspects are achieved by providing a refrigerator, including: a water supply source; a dispenser; a water supply device which provides a flow path connected between the water supply source and the dispenser and supplies water to the dispenser by opening and closing a flow rate control valve installed on the flow path; an input unit to set a water supply amount of water to be supplied through the dispenser; and a valve driving unit which continuously supplies a driving voltage to the flow rate control valve in a start-up operation and discontinuously supplies a driving voltage to the flow rate control valve when the set water supply amount is supplied after the start-up operation.

The foregoing and/or other aspects are achieved by providing a method of controlling a refrigerator which includes a water supply source, a dispenser, and a water supply device which provides a flow path connected between the water supply source and the dispenser and supplies water to the dispenser by opening and closing a flow rate control valve installed on the flow path, the method comprising: determining an operation mode; applying a first driving voltage to the valve when the operation mode is a first operation mode; and applying a second driving voltage, which has an average voltage smaller than that of the first driving voltage, to the valve when the operation mode is a second operation mode which is performed after the first operation mode.

The first operation mode may be a start-up operation and the second operation mode may be an operation to supply water to the dispenser by driving the valve.

The applying a second driving voltage may include controlling a ratio of supply to supply interruption of the driving voltage applied to the valve in order to reduce an average voltage of the driving voltage.

As described above, according to the present embodiment, the phase of the driving voltage applied to the water valve is controlled to reduce an average voltage, thereby preventing a malfunction due to overheat of the water valve.

The foregoing and/or other aspects are achieved by providing a water supply device for a refrigerator, including: a flow path connecting a water supply for the water supply device and a dispenser to dispense water; a flow rate control valve installed in the flow path supplying the water to the dispenser by being opened and closed; and a valve driving unit continuously supplying a driving voltage to the control valve in a start-up operation and discontinuously supplying a driving voltage to the control valve when a water supply amount is supplied after the start-up operation.

The foregoing and/or other aspects are achieved by providing a method of controlling a refrigerator, including: supplying a first driving voltage to a water valve; determining whether there is a selection of a water supply mode using a water lever or an input unit after supplying the first driving voltage to the water valve; and supplying a second driving voltage having a reduced average voltage compared to the first driving voltage to the water valve when it is determined that there is a selection of the water supply mode.

The method further includes: determining whether there is an operation of setting a desired water supply amount in the selected water supply mode; and causing a first outlet of the water valve to open when it is determined that there is the operation of setting the desired water supply amount.

### BRIEF DESCRIPTION OF THE DRAWINGS

These and/or other aspects and advantages will become apparent and more readily appreciated from the following description of the embodiments, taken in conjunction with the accompanying drawings, of which:

FIG. 1 schematically illustrates the refrigerator according to an embodiment;

FIG. 2 illustrates a cross-sectional view of a water valve according to the embodiment;

FIG. 3 is a block diagram for controlling the refrigerator according to the embodiment;

FIG. 4A illustrates a graph of a first driving voltage to be applied to the water valve of the present embodiment;

FIG. 4B illustrates a graph of a second driving voltage to be applied to the water valve of the present embodiment;

FIG. 5 illustrates a graph showing the temperature of the water valve which varies according to the kind of driving voltage applied to the water valve of the present embodiment; and

FIG. 6 illustrates a flowchart to explain a method of controlling the refrigerator according to the present embodiment.

### DETAILED DESCRIPTION OF THE EMBODIMENT

Reference will now be made in detail to the embodiment, examples of which are illustrated in the accompanying drawings, wherein like reference numerals refer to like elements throughout. The embodiment is described below to explain the present invention by referring to the figures.

Hereinafter, a refrigerator and a control method thereof according to an embodiment will be described in detail.

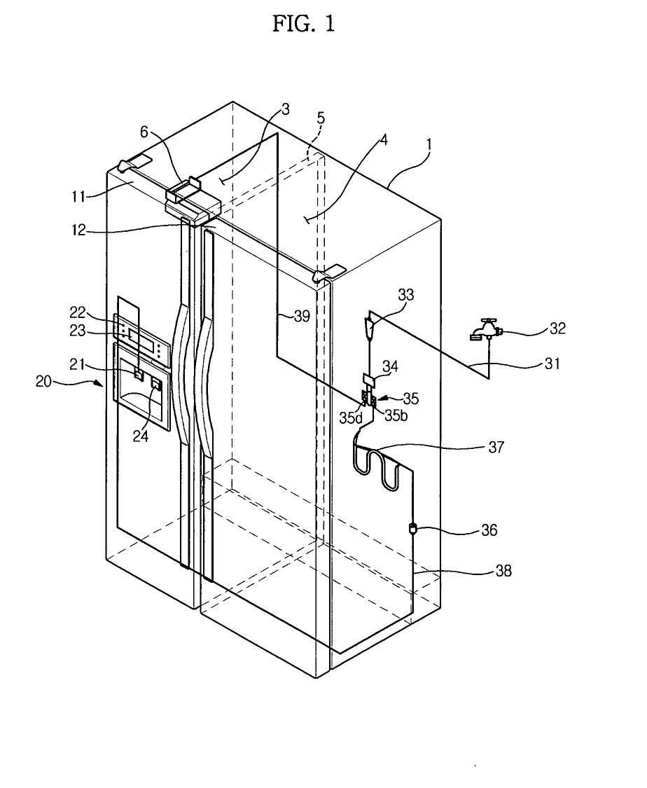

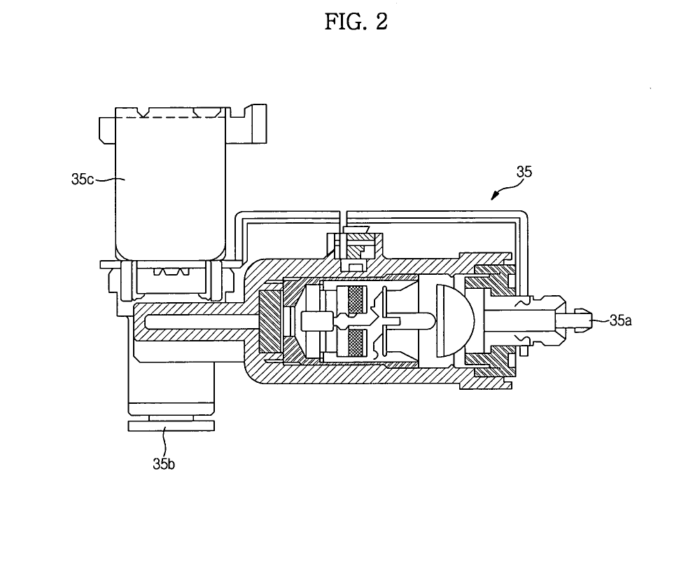

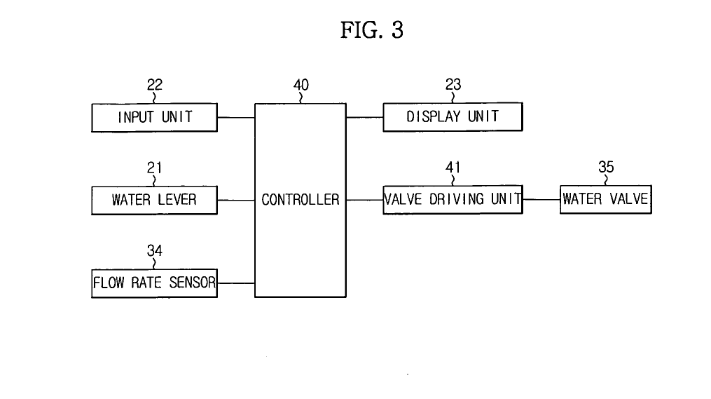

FIG. 1 schematically illustrates the refrigerator according to the embodiment. FIG. 2 illustrates a cross-sectional view of a water valve according to the present embodiment. FIG. 3 is a block diagram for controlling the refrigerator according to the present embodiment.

As shown in FIG. 1, the refrigerator according to the present embodiment includes a main body 1 which has a freezing chamber 3 and a cooling chamber 4 separated by an intermediate partition wall 5, and a freezing chamber door 11 and a cooling chamber door 12 which open and close the freezing chamber 3 and the cooling chamber 4, respectively.

An ice maker 6 is installed at an upper portion of the freezing chamber 3 to make ice. Further, a dispenser 20 is installed on a front surface of the freezing chamber door 11 to supply ice made in the ice maker 6 and cold water. The dispenser 20 may alternatively be disposed on a front surface of the cooling chamber door 12.

A water lever 21 that supplies water and an ice lever 24 that supplies ice are disposed at the dispenser 20.

An input unit 22 to which user commands are inputted to set a water supply mode and to operate the refrigerator, and a display unit 23 which displays information regarding a water supply amount and an operation state are disposed near the dispenser 20. In this case, the input unit 22 and the display unit 23 may be configured as one body in the form of a touch screen.

A water supply device according to the present embodiment includes a first water supply line 31 which is connected to an external water supply source 32, and a second water supply line 38 and a third water supply line 39 which diverge from the first water supply line 31.

The second water supply line 38 provides a flow path which supplies water to the dispenser 20. The third water supply line 39 provides a flow path which supplies water to the ice maker 6.

A water purifying unit 33 is installed in the middle of the first water supply line 31 to purify water introduced from the water supply source 32. A flow rate sensor 34 which detects a water supply amount and a water valve 35 having a plurality of outlets are disposed at one end of the first water supply line 31. An inlet 35a (shown in FIG. 2) of the water valve 35 is connected to the outlet of the flow rate sensor 34. The purified water is supplied to the flow rate sensor 34 and the water valve 35.

A first outlet 35b of the water valve 35 is connected to the second water supply line 38 diverging from the first water supply line 31. A second outlet 35d of the water valve 35 is connected to the third water supply line 39 diverging from the first water supply line 31. The water valve 35 includes a coil 35c (shown in FIG. 2) to operate a plunger. A driving voltage is applied to the coil 35c.

The opening and closing operations of the first outlet 35b and the second outlet 35d of the water valve 35 are performed by a controller 40.

A cold water tank 37 which accommodates a certain amount of water and a coupler 36 are installed on the second water supply line 38. One side of the coupler 36 is connected to an outlet of the cold water tank 37, and the other side of the coupler 36 is connected to the water lever 21.

As one method of supplying water to the dispenser 20, the water valve 35 is temporarily opened only while the water lever 21 is operated by the user such that the user can be supplied with water. That is, when the user operates the water lever 21 with a cup, the controller 40 opens the water valve 35 such that the water stored in the cold water tank 37 passes through the coupler 36 disposed at the downstream side and is discharged to the outside through an outlet port (not shown) which is installed near the water lever 21 to be exposed to the outside. During the supply of water, when the operation of the water lever 21 is stopped, the water valve 35 is closed to interrupt the supply of water.

As another method, the water supply is automatically performed by setting a desired water supply amount. That is, when a desired water supply amount is set through the input unit 22, the controller 40 opens the water valve 35 such that the dispenser 20 is supplied with water. When a set amount of water is supplied, the water valve 35 is closed to interrupt the supply of water.

In both cases of supplying water using the water lever 21 as in the former method and supplying water by setting a water supply amount through the input unit 22 as in the latter method, when the water valve 35 is opened, the flow rate sensor 34 detects a variation in the water supply amount and provides a detection signal to the controller 40.

The controller 40 perceives the water supply amount based on the detection signal of the flow rate sensor 34. When the water supply operation is finished, the water supply amount is displayed on the display unit 23 such that the user can check the water supply amount.

The controller 40 controls a valve driving unit 41 to control opening and closing operations of the first and second outlets 35b and 35d of the water valve 35 and a phase of a driving voltage applied to the coil 35c.

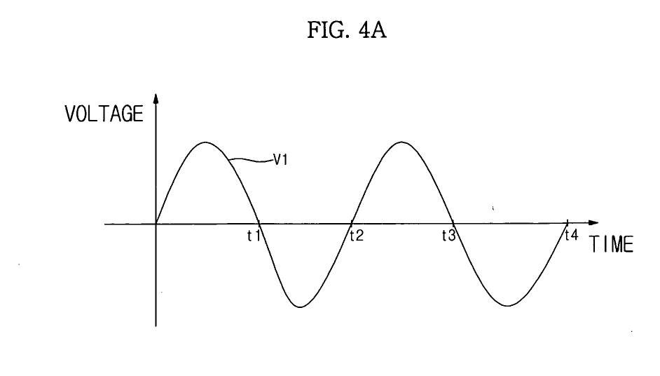

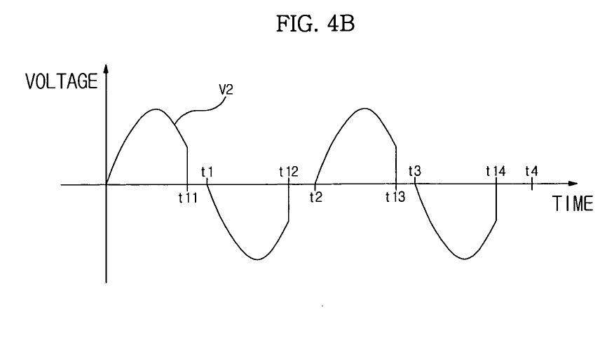

According to the control of the controller 40, the valve driving unit 41 may apply a first driving voltage V1 without interruption as shown in FIG. 4A, or may apply a second driving voltage V2 with periodic interruption as shown in FIG. 4B.

According to the environment in which the refrigerator is used, if the first driving voltage V1 applied to the water valve 35 is excessive, the water valve 35 may be overheated. Accordingly, the second driving voltage V2 is applied to the water valve 35 to reduce the supply power compared to the first driving voltage V1. Since the second driving voltage V2 is not supplied periodically for specified periods t11˜t1, t12˜t2, t13˜t3 and t14˜4, the average voltage of the second driving voltage is reduced compared to the first driving voltage V1.

When the first driving voltage V1 is supplied as power of the refrigerator, the valve driving unit 41 controls the phase of the first driving voltage V1 to generate the reduced second driving voltage V2, and then applies the generated second driving voltage V2 to the water valve 35. A method of controlling the phase may employ a pulse width modification method in which a ratio of supply to interruption of supply is set. In this case, if a reduced rate of the average voltage is excessively large, the water valve 35 may have a poor sustaining force against the plunger. Accordingly, the reduced rate may be set at 10˜15%, for example.

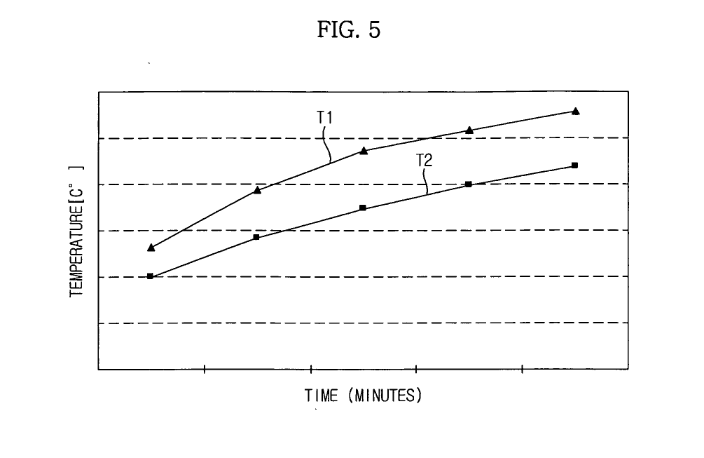

Referring to FIG. 5, a first temperature T1 of the water valve 35 applied with the first driving voltage V1 and a second temperature T2 of the water valve 35 applied with the second driving voltage V2 increase according to the applying time. It can be seen that the second temperature T2 is in a temperature range smaller than the first temperature T1. Thus, the second driving voltage V2 is favorable compared to the first driving voltage V1 to prevent the water valve 35 from being overheated.

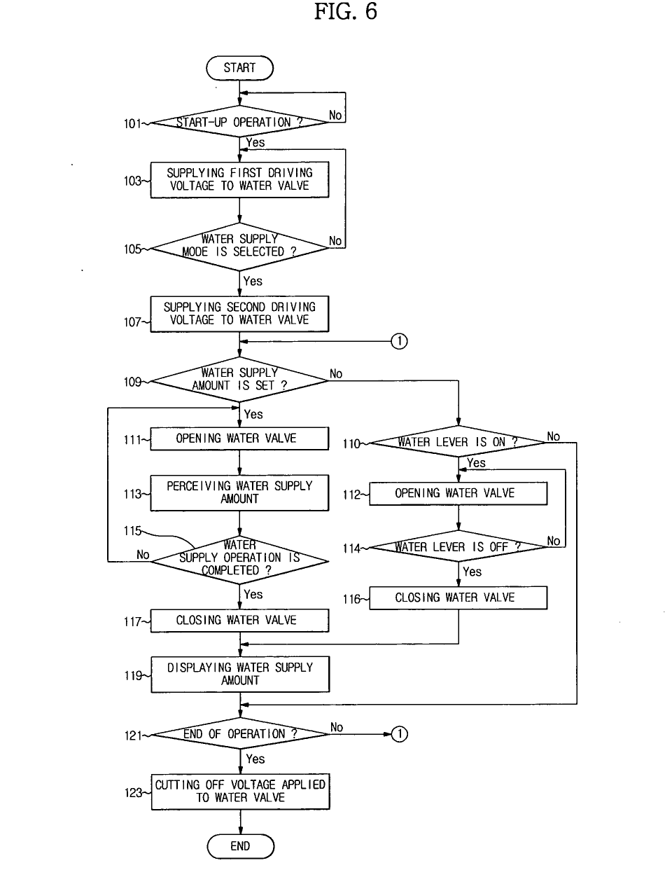

The controller 40 may employ a method of always applying the second driving voltage V2 to the water valve 35. As in the embodiment illustrated in FIG. 6, the first and second driving voltages V1 and V2 may be selectively applied to the water valve 35 by distinguishing a start-up operation from a normal operation.

In the latter method, in the start-up operation to supply power to the refrigerator, the first driving voltage V1 is applied to the water valve 35 as shown in FIG. 4A. After the start-up operation is completed, when the water valve 35 is opened to supply water or when the water valve 35 is closed to interrupt the water supply, the second driving voltage V2 is applied to the water valve 35 as shown in FIG. 4B. The start-up operation is generally performed for a few seconds, and the substantial operation of the water valve 35 is performed in the normal operation. Taking this point into account, also when the first driving voltage is supplied for a short period of time and the second driving voltage is supplied after the start-up operation, it is favorable to prevent the water valve 35 from being overheated.

Hereinafter, a control method of the refrigerator according to the present embodiment will be described with reference to the accompanying drawings.

When the refrigerator is supplied with power, the controller 40 determines whether it is a start-up operation (101).

If it is a start-up operation, the controller 40 controls the valve driving unit 41 to supply the first driving voltage V1 to the water valve 35 (103). Then, the controller 40 determines whether there is a selection of a water supply mode using the water lever 21 or the input unit 22 (105).

As a result of the determination, if there is a selection of a water supply mode, the controller 40 controls the valve driving unit 41 to supply the water valve 35 with the second driving voltage V2 having a reduced average voltage compared to the first driving voltage V1 (107). Otherwise, the process returns to operation 103 cause the controller 40 to control the valve driving unit 41 to supply the first driving voltage V1 to the water valve 35.

Then, the controller 40 determines whether there is an operation of setting a desired water supply amount using the input unit 22 in the selected water supply mode (109). As a result of the determination, if there is an operation of setting a water supply amount, the controller 40 controls the valve driving unit 41 to open the first outlet 35b of the water valve 35 (111). Accordingly, water introduced from the water supply source 32 is supplied to the cold water tank 37 through the first water supply line 31, the water purifying unit 33, the flow rate sensor 34 and the water valve 35. As a water pressure increases due to an increase in the flow rate of the cold water tank 37, water stored in the cold water tank 37 is transferred to the dispenser 20 through the second water supply line 38 and is discharged to the outside. During the water supply, the flow rate sensor 34 provides a detection signal to the controller 40 and the controller 40 perceives a water supply amount based on the detection signal of the flow rate sensor 34 (113).

Then, the controller 40 compares the detected water supply amount with the water supply amount set by the user through the input unit 22 to determine whether the water supply operation is completed (115). If the detected water supply amount is smaller, the process returns to operation 111 to continuously supply water. If the detected water supply amount is equal to the set water supply amount, the controller 40 controls the valve driving unit 41 to close the first outlet 35b of the water valve 35 (117).

As a determination result in the operation 109, if there is no operation of setting a water supply amount, the controller 40 determines whether there is a water supply mode using the water lever 21, that is, whether the water lever 21 is in an ON state (110).

As a determination result in the operation 110, if the water lever 21 is not in an ON state, the process proceeds to an operation 121.

As a determination result in the operation 110, if the water lever 21 is in an ON state, the controller 40 controls the valve driving unit 41 to open the first outlet 35b of the water valve 35 (112). Accordingly, water is supplied from the water supply source 32 to the cold water tank 37. An increased amount of water in the cold water tank 37 is transferred to the dispenser 20 through the second water supply line 38 and then is discharged to the outside. During the water supply, the flow rate sensor 34 provides a detection signal to the controller 40 and the controller 40 perceives a water supply amount based on the detection signal of the flow rate sensor 34. The controller 40 determines whether the water lever 21 is thereafter in an OFF state (114). If the water lever 21 is not in an OFF state, the process returns to an operation 112 to continuously supply water. If the water lever 21 is in an OFF state, the controller 40 controls the valve driving unit 41 to close the first outlet 35b of the water valve 35 (116).

When the water supply operation is completed by performing the operation 117 or 116, the controller 40 displays information regarding the water supply amount on the display unit 23 (119). Then, the controller 40 determines whether there is an operation end command to complete the operation of the refrigerator (121). If there is no operation end command, the process returns to the operation 109 to repeat the above-described operations. If there is an operation end command, the controller 40 completes the operation by cutting off the second driving voltage applied to the water valve 35 (123).

Although an embodiment has been shown and described, it would be appreciated by those skilled in the art that changes may be made in this embodiment without departing from the principles and spirit of the invention, the scope of which is defined in the claims and their equivalents.

What is claimed is:

1. A refrigerator, comprising:
a dispenser;
a water supply line to supply water to the dispenser;
a water valve disposed on the water supply line;
a valve driving unit to drive the water valve; and
a controller controlling the valve driving unit to selectively apply a plurality of driving voltages having different average voltages to the water valve according to an operation mode.

2. The refrigerator according to claim 1, wherein the controller applies a driving voltage having a high average voltage to the water valve in a start-up operation and applies a driving voltage having a low average voltage to the water valve after the start-up operation.

3. The refrigerator according to claim 2, wherein the valve driving unit controls a ratio of supply to interrupt supply of the driving voltage in order to adjust the average voltage.

4. The refrigerator according to claim 2, wherein the water valve includes a coil to be applied with the driving voltage.

5. A refrigerator having a dispenser, comprising:
a valve disposed on a flow path through which water is supplied to the dispenser;
a valve driving unit applying a driving voltage to the valve; and
a controller controlling the valve driving unit to apply a second driving voltage having an average voltage smaller than that of a first driving voltage supplied to the refrigerator to the valve.

6. The refrigerator according to claim 5, wherein the valve driving unit controls a ratio of supply to interrupt supply of the driving voltage in order to reduce the average voltage.

7. The refrigerator according to claim 6, wherein a reduced rate of the average voltage is approximately 10˜15%.

8. A refrigerator, comprising:
a water supply source;
a dispenser;
a water supply device providing a flow path connected between the water supply source and the dispenser and supplying water to the dispenser by opening and closing a flow rate control valve installed on the flow path;
an input unit to set a water supply amount of water to be supplied through the dispenser; and
a valve driving unit continuously supplying a driving voltage to the flow rate control valve in a start-up operation and discontinuously supplying a driving voltage to the flow rate control valve when the set water supply amount is supplied after the start-up operation.

9. A method of controlling a refrigerator including a water supply source, a dispenser, and a water supply device providing a flow path connected between the water supply source and the dispenser and supplying water to the dispenser by opening and closing a flow rate control valve installed on the flow path, the method comprising:
determining an operation mode;
applying a first driving voltage to the valve when the operation mode is a first operation mode; and
applying a second driving voltage having an average voltage smaller than that of the first driving voltage to the valve when the operation mode is a second operation mode, the second operation mode being performed after the first operation mode.

10. The method according to claim 9, wherein the first operation mode is a start-up operation and the second operation mode is an operation to supply water to the dispenser by driving the valve.

11. The method according to claim 9, wherein the applying a second driving voltage includes: controlling a ratio of supply to interrupt supply of the driving voltage applied to the valve in order to reduce an average voltage of the driving voltage.

12. A water supply device for a refrigerator, comprising:
a flow path connecting a water supply for the water supply device and a dispenser to dispense water;
a flow rate control valve installed in the flow path supplying the water to the dispenser by being opened and closed; and
a valve driving unit continuously supplying a driving voltage to the control valve in a start-up operation and discontinuously supplying a driving voltage to the control valve when a water supply amount is supplied after the start-up operation.

13. A method of controlling a refrigerator, comprising:
supplying a first driving voltage to a water valve;
determining whether there is a selection of a water supply mode using a water lever or an input unit after supplying the first driving voltage to the water valve; and
supplying a second driving voltage having a reduced average voltage compared to the first driving voltage to the water valve when it is determined that there is a selection of the water supply mode.

14. The method according to claim 13, further comprising:
determining whether there is an operation of setting a desired water supply amount in the selected water supply mode; and
causing a first outlet of the water valve to open when it is determined that there is the operation of setting the desired water supply amount.
